(19) United States
(12) Patent Application Publication
(10) Pub. No.: US 2014/0245608 A1
(43) Pub. Date: Sep. 4, 2014

(54) METHOD AND APPARATUS FOR LASER-BEAM PROCESSING AND METHOD FOR MANUFACTURING INK JET HEAD

(71) Applicant: CANON KABUSHIKI KAISHA, Ohta-ku, Tokyo (JP)

(72) Inventors: Hiroyuki Morimoto, Tokyo (JP); Kosuke Kurachi, Yokohama-shi (JP)

(73) Assignee: Canon Kabushiki Kaisha, Ohta-ku, Tokyo (JP)

(21) Appl. No.: 14/349,477

(22) PCT Filed: Oct. 3, 2012
(86) PCT No.: PCT/JP2012/006324

§ 371 Date: Apr. 3, 2014

(30) Foreign Application Priority Data
Oct. 7, 2011 (JP) 2011-222731
Dec. 15, 2011 (JP) 2011-274375

(51) Int. Cl. B23K 26/36; B23K 26/40; B41J 2/16; B23K 26/12

(52) U.S. Cl. CPC B23K 26/365; B23K 26/121; B23K 26/407; B41J 2/16
USPC 29/890.1; 219/121.69; 219/121.76; 219/121.75; 219/121.8; 219/121.84

(57) ABSTRACT

In removal processing using a pulsed laser beam, processing deviation occurs in the depthwise direction to cause a processing error in a predetermined removal shape.

A first pulsed laser beam L1 is a pulsed laser beam having a wavelength that exhibits transmittance to a workpiece 6, and a second pulsed laser beam L2 is a pulsed laser beam having a wavelength that exhibits absorption to the workpiece 6. The first pulsed laser beam L1 is focused into the workpiece 6, and a focal point P1 of the first pulsed laser beam L1 is scanned along the outline of a predetermined removal region R1 to form a modified portion 6A along the outline of the predetermined removal region R1. Next, removal processing is performed by scanning the second pulsed laser beam L2 in a region enclosed by the modified portion 6A.

### 1. TECHNICAL FIELD

The present invention relates to a laser-beam processing method and apparatus for removing a predetermined removal region of a workpiece with a pulsed laser beam, and a method for manufacturing an ink jet head.

### 2. BACKGROUND ART

A known technique in the related art performs removal processing using a pulsed laser beam (see NPL 1). According to NPL 1, a pulsed laser beam is focused on a workpiece with a focusing lens, and a reflecting mirror in the optical path is driven to move a focal point on the workpiece, so that the workpiece is machined with the laser beam as the focal point moves, and hence a hole of a desired size can be obtained.

However, in the processing of a hole or a groove, an angular deviation (hereinafter referred to as a cone angle) relative to the incident direction of the laser beam sometimes occurs on the side wall of the hole or groove as the removal processing advances, thus causing a difference in size between the laser incident side and the exiting side.

The related art solves the above problem by inserting a prism optical system having a rotation mechanism into the optical path and introducing the laser beam at an angle for correcting the cone angle (see PTL 1).

### CITATION LIST

### Patent Literature

PTL 1: Japanese Patent Laid-Open No. 2009-50869

### Non Patent Literature

NPL 1: Progress in R&D on ultrafast laser processing and prospect of industrial applications, LIU Xinbing, Panasonic Boston Lab., MA, USA, presented at Japan Laser Processing Society

However, with the technique of PTL 1, since the locus of the focal point on the workpiece is limited to a circle, it is difficult to remove a portion in a desired shape, such as a rectangular groove.

Furthermore, the cone angle described above changes depending on the laser-beam processing conditions, such as a laser output and the focal spot size, and a change in the material of the workpiece. As a result, for deep holes and grooves, the processing conditions change with an increase in processing depth to cause a change in cone angle, and hence, an error can occur in the processing shape.

### SUMMARY OF INVENTION

Accordingly, the present invention provides a laser-beam processing method and apparatus capable of removal processing in a desired shape, and a method for manufacturing an ink jet head.

A laser-beam processing method according to a first aspect of the present invention includes the steps of forming a modified portion, to form the modified portion in a workpiece by scanning the focal point of a pulsed laser beam having a wavelength that exhibits transmittance to the workpiece along the outline of a predetermined removal region; and removing a region enclosed by the modified portion.

A method for manufacturing an ink jet head including a semiconductor substrate having a groove for supplying ink from an ink tank to an ink discharge port according to a second aspect of the present invention includes the steps of forming a modified region, to form the modified portion in a semiconductor substrate by scanning the focal point of a pulsed laser beam having a wavelength that exhibits transmittance to the semiconductor substrate along the outline of a predetermined groove-formation region; and removing a region enclosed by the modified portion to form the groove.

A laser-beam processing apparatus according to a third aspect of the present invention includes a first laser oscillator that emits a first pulsed laser beam having a wavelength that exhibits light transmittance to a workpiece; a second laser oscillator that emits a second pulsed laser beam having a wavelength that exhibits light transmittance to the workpiece;

an optical system that guides the first pulsed laser beam emitted by the first laser oscillator and the second pulsed laser beam emitted by the second laser oscillator to a common optical path; a focusing lens disposed in the common optical path, the focusing lens focusing the first pulsed laser beam and the second pulsed laser beam guided to the common optical path on a predetermined modification position of the workpiece;

a control unit that controls the pulsed laser beam emission timings of the first laser oscillator and the second laser oscillator so that, when the focal spots of the first pulsed laser beam and the second pulsed laser beam irradiate the predetermined modification position to modify the predetermined modification position, the second laser oscillator emits the second pulsed laser beam in one microsecond after the first laser oscillator completes emission of the first pulsed laser beam; a movable stage on which the workpiece is placed; a laser oscillator that emits a pulsed laser beam having a wavelength that exhibits absorption to the workpiece; and a focusing lens that focuses the pulsed laser beam emitted by the laser oscillator that emits the pulsed laser beam having a wavelength that exhibits absorption on a region enclosed by the predetermined modification position of the workpiece.

### Advantageous Effects of Invention

According to some embodiment of the present invention, since a modified portion formed using a first pulsed laser beam having a wavelength that exhibits transmittance in a workpiece tends to peel off from a base material, a desired shape can be machined with high accuracy by scanning a second pulsed laser beam in a region enclosed by the modified portion.

Further features of the present invention will become apparent from the following description of exemplary embodiments with reference to the attached drawings.

### BRIEF DESCRIPTION OF DRAWINGS

FIG. 1 is an explanatory diagram showing, in outline, the configuration of a laser-beam processing apparatus according to a first embodiment of the present invention.

FIG. 2A is a diagram for explaining a modified region that is formed by focusing a first pulsed laser beam into the interior of a workpiece in a modified-portion forming step.

FIG. 2B is a diagram of the portion of the modified region enclosed by an ellipse in FIG. 2A, as viewed from a direction perpendicular to the optical axis of the first pulsed laser beam.

FIG. 2C is a diagram showing a state in which the modified region is formed in layers in the direction of the optical axis of the pulsed laser beam to form a modified portion along the outline of a predetermined removal region in the workpiece.

FIG. 2D is a diagram showing a state in which the workpiece is subjected to removal processing in a processing step by using a second pulsed laser beam.

FIG. 2E is a partial cross-sectional view of FIG. 2D.

FIG. 3A is a diagram of an ink jet head having a groove formed by using a manufacturing method according to an embodiment of the present invention.

FIG. 3B is a diagram of an ink jet head having a groove formed by conventional removal processing using a pulsed laser beam.

FIG. 4 is an explanatory diagram showing, in outline, the configuration of a laser-beam processing apparatus according to a second embodiment of the present invention.

FIG. 5 is a schematic diagram showing the periods and emission timings of a first pulsed laser beam and a second pulsed laser beam.

FIG. 6A is a cross-sectional view of a substrate after a modified layer is formed in the substrate by the modified-layer forming process.

FIG. 6B is a plan view of the substrate after the modified layer is formed in the substrate.

FIG. 7A is a cross-sectional view of the substrate for explaining a removal processing process for performing removal processing on the substrate.

FIG. 7B is a cross-sectional view of the substrate, showing an example in which the substrate is subjected to part of removal processing in the removal processing process.

FIG. 8A is a cross-sectional view of the substrate, showing a state in which removal processing has reached the modified layer in the substrate in the removal processing process.

FIG. 8B is a cross-sectional view of the substrate subjected to the removal processing in the removal processing process.

FIG. 8C is a plan view of the substrate subjected to the removal processing in the removal processing process.

### DESCRIPTION OF EMBODIMENTS

### First Embodiment

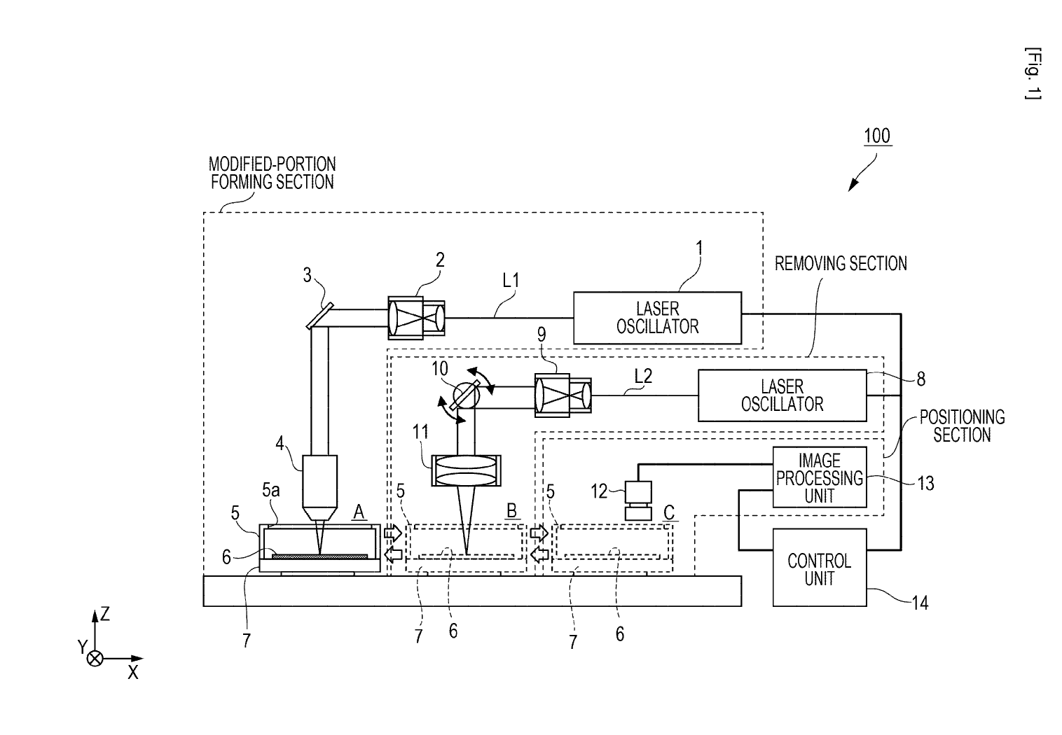

A first embodiment of the present invention will be described in detail hereinbelow with reference to the drawings. FIG. 1 is an explanatory diagram showing, in outline, the configuration of a laser-beam processing apparatus according to the first embodiment of the present invention. The laser-beam processing apparatus 100 shown in FIG. 1 irradiates a workpiece 6 having a cleavage property with a pulsed laser beam to remove a predetermined removal region of the workpiece 6. The laser-beam processing apparatus 100 can be divided into three sections, that is, a positioning section, a modified-portion forming section, and a removing section. An example of the workpiece 6 is a monocrystal silicon wafer. The laser-beam processing apparatus 100 includes a laser oscillator 1 serving as a laser oscillating unit that emits a pulsed laser beam L1 having a wavelength that exhibits transmittance to the workpiece 6. The laser-beam processing apparatus 100 further includes a laser oscillator 8 serving as a laser oscillating unit that emits a pulsed laser beam L2 having a wavelength that exhibits absorption to the workpiece 6, the wavelength being different from the wavelength of the pulsed laser beam L1.

A workpiece made of monocrystal silicon has transmittance to a wavelength of about 1,050 nanometers or more. Accordingly, examples of the pulsed laser beam L1 having a wavelength that exhibits transmittance to the workpiece 6 include a YAG laser and a YVO₄ laser having a fundamental wavelength of 1,064 nanometers, solid-state lasers having wavelength ranges of 1,300 nanometers and 1,500 nanometers, and a carbon dioxide laser having a wavelength of 10,600 nanometers.

Examples of the pulsed laser beam L2 having a wavelength that exhibits absorption to the workpiece 6 include an excimer laser having a wavelength of 248 nanometers, a nitrogen laser having a wavelength of 337.1 nanometers, solid-state lasers having wavelengths of 355 nanometers and 532 nanometers, and a titanium sapphire laser having a wavelength of 780 nanometers.

A workpiece made of quartz glass has transmittance to wavelengths of about 280 nanometers to 2,800 nanometers. Accordingly, examples of the pulsed laser beam L1 having a wavelength that exhibits transmittance to the workpiece 6 include a nitrogen laser having a wavelength of 337.1 nanometers, a YAG laser and a YVO₄ laser having a wavelength of 355 nanometers, 532 nanometers, or 1064 nanometers, a titanium-sapphire laser having a wavelength of 780 nanometers, and solid-state lasers having wavelength ranges of 1,300 nanometers and 1,500 nanometers.

Examples of the pulsed laser beam L2 having a wavelength that exhibits absorption to the workpiece 6 include an excimer laser having a wavelength of 248 nanometers and a carbon dioxide laser having a wavelength of 10,600 nanometers.

That is, the laser beams L1 and L2 may have the property of (transmittance to the workpiece 6)>(absorption at the incident surface of the workpiece 6).

A beam-expansion optical system 2, a reflecting mirror 3, and a focusing lens 4 are disposed in sequence downstream of the laser oscillator 1. The beam-expansion optical system 2 appropriately expands the pulsed laser beam L1 emitted from the laser oscillator 1. The reflecting mirror 3 reflects the pulsed laser beam L1 at 90 degrees. The focusing lens 4 is a focusing unit (first focusing unit) that focuses the pulsed laser beam L1.

A beam-expansion optical system 9, a reflecting mirror 10, and a focusing lens 11 are disposed in sequence downstream of the laser oscillator 8. The beam-expansion optical system 9 appropriately expands the pulsed laser beam L2 emitted from the laser oscillator 8. The reflecting mirror 10 has a rotation mechanism and functions as a second scanning unit that scans the pulsed laser beam L2. The focusing lens 11 is a second focusing unit that focuses the pulsed laser beam L2.

The laser-beam processing apparatus 100 further includes a detector 12 for detecting a positioning mark on the workpiece 6, an image processing unit 13 that converts a signal from the detector 12 to position information, and a control unit 14 that controls the operation of the stage 7, the reflecting mirror 10, and the laser oscillators 1 and 8.

The detector 12 is an image pickup device, such as a CCD camera, connected to the image processing unit 13 and acquires an image of the positioning mark (alignment mark) formed on the workpiece 6. The image processing unit 13 calculates the position of the center of gravity of the positioning mark on the basis of an image signal sent from the detector 12. The control unit 14 is connected to the image processing unit 13, the stage 7, the reflecting mirror 10, and the laser oscillators 1 and 8. The control unit 14 obtains the position and orientation of the workpiece 6 on the basis of the position of the center of gravity calculated by the image processing unit 13 and drives the stage 7 and the reflecting mirror 10 to locate the focal point of the laser beam on the workpiece to a predetermined processing position. The control unit 14 further has the function of oscillating the laser oscillators 1 and 8 at predetermined timing.

The stage 7 serves both as a scanning unit (first scanning unit) and a moving unit movable in the Z-axis direction parallel to the optical axis of the pulsed laser beam L1 that has passed through the focusing lens 4 and in the X-axis direction and the Y-axis direction perpendicular to the Z-axis and orthogonal to each other.

The workpiece 6 can be located at the modified-portion forming section, the removing section, or the positioning section by moving the stage 7. Specifically, the stage 7 moves the workpiece 6 to a first position A (modified-portion forming section) at which the workpiece 6 is to be irradiated with the pulsed laser beam L1 having a wavelength that exhibits transmittance to the workpiece 6. The stage 7 also moves the workpiece 6 to a second position B (removing section) at which the workpiece 6 is to be irradiated with the pulsed laser beam L2 having a wavelength that exhibits absorption to the workpiece 6. The stage 7 also moves the workpiece 6 to a third position C (positioning section) at which the workpiece 6 is to be detected.

Although this embodiment shows an example in which the stage 7 is driven, the present invention is not limited thereto; it is sufficient that the workpiece 6 and the modified-portion forming section, the removing section, and the positioning section can be scanned relatively, and the modified-portion forming section, the removing section, and the positioning section may be moved relative to the workpiece 6.

The operation of the thus-configured laser-beam processing apparatus 100 will be described in detail hereinbelow.

### Positioning Section

The control unit 14 drives the stage 7 to move the workpiece 6 to the third position C directly below the detector 12. The detector 12 detects the positioning mark formed on the workpiece 6 and detects the position of the center of gravity of the positioning mark with the image processing unit 13.

### Modified-Portion Forming Section

Next, the control unit 14 moves the stage 7 to move the workpiece 6 to the first position A directly below the focusing lens 4. At that time, the image processing unit 13 transmits a detection signal to the control unit 14, and the control unit 14 controls the stage 7 to locate the workpiece 6 at a desired processing position directly below the focusing lens 4.

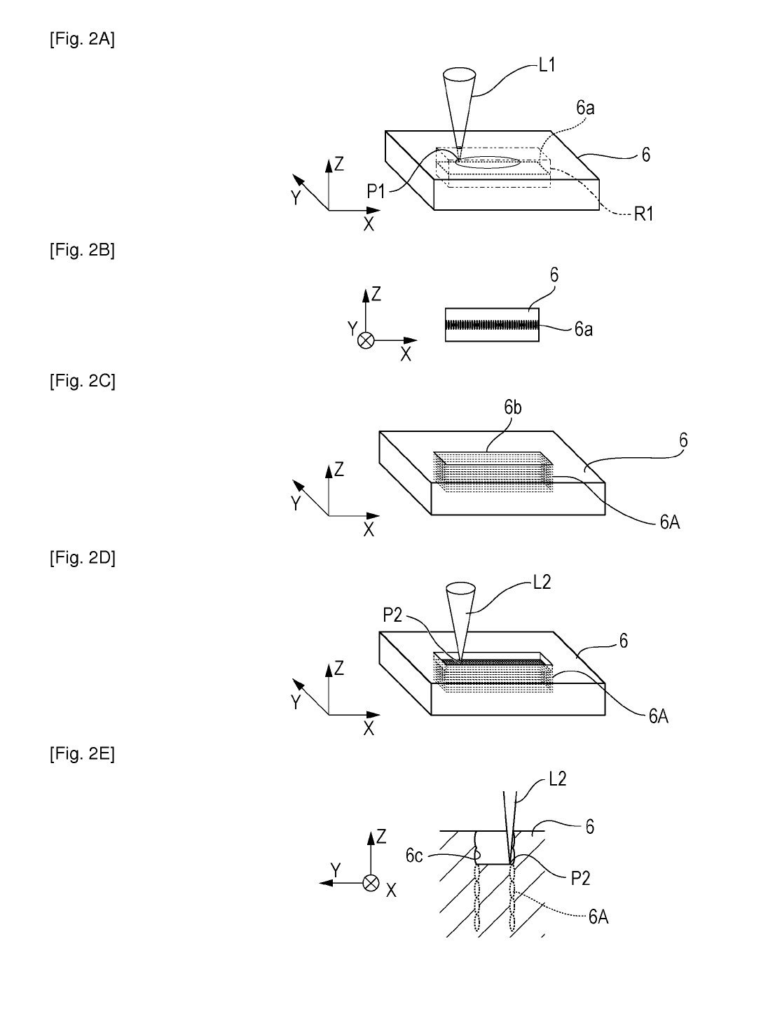

FIGS. 2A to 2E are diagrams for explaining a series of processes at the modified-portion forming section and the removing section by the laser-beam processing apparatus 100 according to an embodiment of the present invention. FIG. 2A is a diagram for explaining a modified region 6a that is formed by focusing the pulsed laser beam L1 having a wavelength that exhibits transmittance to the workpiece 6 into the interior of the workpiece 6 in a modified-portion forming step. FIG. 2B is a diagram of the portion of the modified region 6a enclosed by an ellipse in FIG. 2A, as viewed from a direction perpendicular to the optical axis of the pulsed laser beam L1. FIG. 2C is a diagram showing a state in which the modified region 6a is formed in layers in the direction of the optical axis of the pulsed laser beam L1 (in the depthwise direction) to form a modified portion 6A along the outline of a predetermined removal region R1 in the workpiece 6. FIG. 2D is a diagram showing a state in which the workpiece 6 is subjected to removal processing in a processing step by using the pulsed laser beam L2 having a wavelength that exhibits absorption to the workpiece 6. FIG. 2E is a partial cross-sectional view of FIG. 2D.

First, as shown in FIG. 2A, the pulsed laser beam L1 having a wavelength that exhibits transmittance to the workpiece 6 is focused into the workpiece 6, and the focal point P1 of the pulsed laser beam L1 is scanned along the outline of the predetermined removal region R1. Thus, as shown in FIG. 2C, the modified portion 6A is formed along the outline of the predetermined removal region R1 by using the pulsed laser beam L1 (modified-portion forming step).

Specifically, in this embodiment, the pulsed laser beam L1 having a wavelength that exhibits transmittance to the workpiece 6 is focused by the focusing lens 4 (see FIG. 1), and the stage 7 is moved so that the focal point P1 is located in the workpiece 6. In this way, the stage 7 is driven to adjust the distance between the focusing lens 4 and the workpiece 6 so that the pulsed laser beam L1 emitted from the laser oscillator 1 is focused into the workpiece 6.

Then, the laser oscillator 1 is oscillated to focus the pulsed laser beam L1 into the workpiece 6. In this state, the stage 7 is moved along the outline of the predetermined removal region R1 so that the focal point P1 moves along the outline of the predetermined removal region R1. Although the pulsed laser beam L1 emitted by the laser oscillator 1 has transmittance to the workpiece 6, the workpiece 6 melts partly at the focal point P1. This is because the energy of the pulsed laser beam L1 focuses on the focal point P1. Thus, the modified region 6a is formed along the scanning line, as shown in FIG. 2B. By forming the modified region 6a in layers in the direction of the optical axis of the pulsed laser beam L1 (in the depthwise direction), the modified portion 6A taken along the outline of the predetermined removal region R1 is formed in the workpiece 6, as shown in FIG. 2C.

More specifically, the focal point P1 is located at a position of the outline of the predetermined removal region R1 in the workpiece 6 in the direction of the optical axis (Z-axis), and the focal point P1 is scanned along the outline of the pulsed laser beam L1 in two directions perpendicular to the optical axis (Z-axis) (main scanning). Thus, as shown in FIG. 2A, the modified region 6a is formed on a main scanning line parallel to a plane (X-Y plane) perpendicular to the optical axis. Furthermore, the focal point P1 is sequentially moved in the direction of the optical axis (Z-axis) (sub-scanning) and is similarly scanned in the directions of the X-Y axes, so that the modified portion 6A taken along the outline of the predetermined removal region R1 is finally formed, as shown in FIG. 2C.

Here, although an example in which the focal point P1 is scanned by moving the stage 7 is shown, the present invention is not limited thereto; the focal point P1 of the laser beam L1 may be moved by the optical system.

In this embodiment, as shown in FIG. 2C, an end 6b of the modified region 6A closest to the surface of the workpiece 6 reaches the surface of the workpiece 6 to form the outline. However, even if the end 6b of the modified region 6A does not reach the surface of the workpiece 6 to form no outline, the position of the outline in the workpiece 6 can be calculated from the position information of the positioning mark (alignment mark), and hence, there is no problem in a laser removal processing, described later.

### Removing Section

Next, the control unit 14 moves the stage 7 to move the workpiece 6 to the second position B directly below the focusing lens 11. As shown in FIG. 2D, by scanning the workpiece 6 with the pulsed laser beam L2 having a wavelength at which absorption to the workpiece 6 is shown in the region enclosed by the modified portion 6A, removal processing is performed (processing step).

Specifically, in this embodiment, the stage 7 is moved so that the pulsed laser beam L2 having a wavelength that exhibits absorption to the workpiece 6 is focused on the workpiece 6 by the focusing lens 11, and that the focal point (processing point) P2 is located on the surface of the workpiece 6. Thus, the stage 7 is driven to adjust the distance between the focusing lens 11 and the workpiece 6 so that the pulsed laser beam L2 emitted from the laser oscillator 8 focuses on the surface of the workpiece 6.

Then, the laser oscillator 8 is oscillated, and the reflecting mirror 10 is driven to scan the focal point P2 on the surface of the workpiece 6. Since the pulsed laser beam L2 emitted from the laser oscillator 8 has absorption to the workpiece 6, the laser-beam focused portion on the workpiece 6 is removed by using the laser beam L2. Although an example in which the focal point P2 is scanned by moving the stage 7 is shown here, the present invention is not limited thereto; the focal point P2 of the laser beam L2 may be moved by the optical system.

Since the workpiece 6 of this embodiment is made of monocrystal silicon, it has a crystal structure having a cleavage property along the crystal orientation surface. The vicinity of the modified portion 6A tends to cleave (peel off) from the base material because of residual stress generated due to the modification using the pulsed laser beam L1. When the silicon is removed by using the absorptive pulsed laser beam L2, a pressure impact occurs at the processing point P2. When there is an appropriate relationship between the focal point P2 and the modified portion 6A, the pressure impact exerts an influence on the modified portion 6A to cause cleavage (peel-off).

Accordingly, in this embodiment, the region enclosed by the modified portion 6A is removed using the pulsed laser beam L2. Thus, the modified portion 6A peels off from the base material, and a side wall surface 6c having a shape along the modified portion 6A (vertical shape) is formed, as shown in FIG. 2E. Thus, a desired shape, such as a hole and a groove, can be machined with high accuracy.

At that time, as shown in FIG. 2E, the focal point P2 of the pulsed laser beam L2 may be scanned so as to come into contact with the modified portion 6A or overlap with part of the modified portion 6A. Alternatively, the focal point P2 may be scanned in a state in which the focal point P2 is separated from the modified portion 6A in a range in which the pressure impact of the pulsed laser beam L2 reaches the modified portion 6A. The positional relationship between the modified portion 6A and the focal point P2 changes depending on the material of the workpiece 6, transmissive-wavelength pulsed laser conditions, and absorptive-wavelength pulsed laser conditions. Accordingly, conditions that basically cause cleavage have only to be satisfied, and the positional relationship between the modified portion 6A and the focal point P2 is not particularly limited. That is, it is sufficient to scan the focal point P2 in a range in which the modified portion 6A peels off.

This offers the advantages of decreasing the output of the absorptive pulsed laser beam L2, increasing the distance between the modified portion 6A and the focal point P2, and so on, thus increasing the efficiency and reliability of removal processing. In particular, since this allows the pressure impact to be effectively propagated to the modified portion 6A, the modified portion 6A can be efficiently peeled off.

Furthermore, in this embodiment, the cone angle is not corrected but the boundary of the predetermined removal region R1 is defined by the position of the modified portion 6A. Thus, a desired removal shape can be obtained with high accuracy. Furthermore, complicated adjustment of the laser oscillators 1 and 8 and the other units is not needed, and hence, man hour required for the operation can be remarkably reduced.

In this embodiment, although an example in which the focal points P1 and P2 are scanned by driving the stage 7 is described, the present invention is not limited thereto; the workpiece 6 and the focal points P1 and P2 have only to be scanned relatively. For example, the laser beams L1 and L2 may also be moved relative to the workpiece 6.

### Second Embodiment

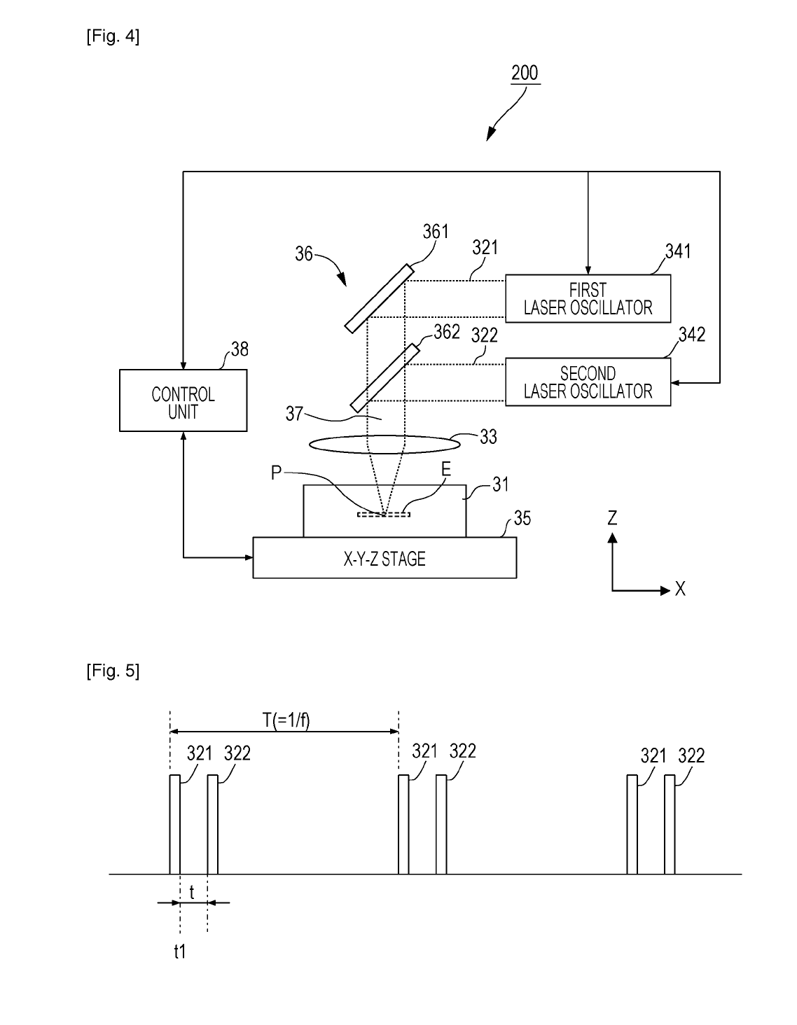

A second embodiment of the present invention will be described in detail hereinbelow with reference to the drawings. FIG. 4 is an explanatory diagram showing, in outline, the configuration of a modified-portion forming section 200 of a laser-beam processing apparatus according to the second embodiment of the present invention. The modified-portion forming section 200 of this embodiment includes a first laser oscillator 341, a second laser oscillator 342, an optical system 36, a focusing lens 33, an X-Y-Z stage 35 serving as a scanning section movable in the X-, Y-, and Z-directions, on which a substrate 31 is placed, and a control unit 38 serving as a control section. The X-direction in FIG. 4 is parallel to the surface of the substrate 31 adjacent to the focusing lens 33 or the surface opposite the focusing lens 33. The Z-direction is the direction of the normal to the surface of the substrate 31 adjacent to the focusing lens 33 or the surface opposite the focusing lens 33. The Z-direction can be reworded as a direction in which the substrate 31 and the focusing lens 33 face each other. The Y-direction is a direction perpendicular to the X-direction and the Z-direction.

The first laser oscillator 341 is a pulsed laser oscillator that emits a first pulsed laser beam 321 having a wavelength that exhibits light transmittance to the substrate 31. The second laser oscillator 342 is a pulsed laser oscillator that emits a second pulsed laser beam 322 having a wavelength that exhibits light transmittance to the substrate 31. The first pulsed laser beam 321 and the second pulsed laser beam 322 may have the property of (transmittance to the substrate 31)>(absorption at the incident surface of the substrate 31).

The optical system 36 includes a reflecting mirror 361 and a beam splitter 362. The reflecting mirror 361 is disposed at an inclination of 45 degrees at a position facing the first laser oscillator 341, and the beam splitter 362 is disposed at an inclination of 45 degrees at a position facing the second laser oscillator 342. The reflecting mirror 361, the beam splitter 362, the focusing lens 33, and the X-Y-Z stage 35 are sequentially disposed on a straight line.

The reflecting mirror 361 receives the first pulsed laser beam 321 emitted by the first laser oscillator 341 and reflects it at right angles toward the X-Y-Z stage 35 (toward the substrate 31), that is, toward the beam splitter 362.

An example of the beam splitter 362 is a half mirror, which receives the first pulsed laser beam 321 reflected from the reflecting mirror 361, allows part (half) of the first pulsed laser beam 321 to pass therethrough and to travel in a straight line, and reflects the remaining part (half) at right angles. Thus, the first pulsed laser beam 321 that has passed through the beam splitter 362 is guided to a common optical path 37 that reaches the substrate 31 via the focusing lens 33.

The beam splitter 362 also receives the second pulsed laser beam 322 emitted by the second laser oscillator 342 and reflects part (half) thereof toward the X-Y-Z stage 35 (toward the substrate 31). Thus, the second pulsed laser beam 322 reflected from the beam splitter 362 is guided to the common optical path 37 that reaches the substrate 31 via the focusing lens 33. The remaining part (half) of the second pulsed laser beam 322 incident on the beam splitter 362 passes therethrough to travel in a straight line.

Thus, the optical system 36 guides the first pulsed laser beam 321 emitted by the first laser oscillator 341 and the second pulsed laser beam 322 emitted by the second laser oscillator 342 to the common optical path 37.

The beam splitter 362 is not limited to the half mirror; any splitter that allows the first pulsed laser beam 321 to pass therethrough and that reflects the second pulsed laser beam 322 may be used. The beam splitter 362 may be a polarizing beam splitter, in which case the first pulsed laser beam 321 incident on the beam splitter 362 may be P-polarized light, and the second pulsed laser beam 322 incident on the beam splitter 362 may be S-polarized light.

The focusing lens 33 is disposed in the common optical path 37 and focuses the first pulsed laser beam 321 and the second pulsed laser beam 322 guided to the common optical path 37 to the predetermined modification position P in the substrate 31 to form a focal spot. This predetermined modification position P is part of an entire predetermined modification region E of the substrate 31, which is a region to be irradiated with the focal spot.

The X-Y-Z stage 35 is configured to be movable in the X-, Y-, and Z-directions and scans the placed substrate 31 with the pulsed laser beams 321 and 322 by moving the substrate 31 in the X-, Y-, and Z-directions.

The control unit 38 controls the movement of the X-Y-Z stage 35 in the X-, Y-, and Z-directions and controls the repetition frequency (period) and emission timing of the pulsed laser beams 321 and 322 from the first laser oscillator 341 and the second laser oscillator 342.

In this embodiment, the control unit 38 controls the laser oscillators 341 and 342 as follows when modifying the predetermined modification position P of the substrate 31 by irradiating the predetermined modification position P with the focal spots of the first pulsed laser beam 321 and the second pulsed laser beam 322.

FIG. 5 is a schematic diagram showing the periods and emission timings of the first pulsed laser beam 321 and the second pulsed laser beam 322. In this embodiment, the control unit 38 controls the first laser oscillator 341 so that it oscillates the first pulsed laser beam 321 having a fixed repetition frequency f (fixed period T). The control unit 38 also controls the second laser oscillator 342 so that it oscillates the second pulsed laser beam 322 at a fixed repetition frequency f (fixed period T). That is, the emission period (repetition frequency) of the first pulsed laser beam 321 emitted by the first laser oscillator 341 and the emission period (repetition frequency) of the second pulsed laser beam 322 emitted by the second laser oscillator 342 are set to the same period.

The control unit 38 also controls the first laser oscillator 341 and the second laser oscillator 342 so that the emission timings are out of sync to allow the first pulsed laser beam 321 and the second pulsed laser beam 322 to be emitted alternately, thereby preventing the first pulsed laser beam 321 and the second pulsed laser beam 322 from irradiating the substrate 31 at the same time. That is, as shown in FIG. 5, the control unit 38 controls the first laser oscillator 341 so that it emits the first pulsed laser beam 321 (first step). Next, the control unit 38 causes the second laser oscillator 342 to emit the second pulsed laser beam 322 after a lapse of fixed time t from the emission completion timing t1 of the first pulsed laser beam 321 by the first laser oscillator 341 (second step).

The fixed time t is set in the range of zero or more and one microsecond or less. Thus, the predetermined modification position P irradiated with the focal spot of the first pulsed laser beam 321 is irradiated with the focal spot of the subsequent second pulsed laser beam 322 before energy, such as heat, diffuses to the periphery. The fixed time t is preferably set to be longer than the pulse time width of the first pulsed laser beam 321 and shorter than or equal to one microsecond, provided that the pulse time width of the first pulsed laser beam 321 should be shorter than one microsecond.

The repetition frequency f is set to less than 1/(t*2). Although the repetition frequency f may be as low as possible because it causes less thermal damage due to heat storage, this increases the processing time. Therefore, the repetition frequency f is appropriately set in consideration of thermal damage and processing time.

Thus, the control unit 38 controls the emission timings of the first and second pulsed laser beams 321 and 322. Specifically, the control unit 38 controls the timings so that the second laser oscillator 342 emits the second pulsed laser beam 322 in one microsecond after the first laser oscillator 341 completes emission of the first pulsed laser beam 321.

Thus, the focal spot of the second pulsed laser beam 322 irradiates the predetermined modification position P of the substrate 31 always after the fixed time t from radiation of the focal point of the first pulsed laser beam 321. That is, after a lapse of fixed time t after the predetermined modification position P of the substrate 31 is irradiated with the focal spot of the first pulsed laser beam 321 in the first step, the focal spot of the predetermined modification position P irradiated with the focal spot of the first pulsed laser beam 321 is irradiated with the focal spot of the second pulsed laser beam 322 in the second step.

The time during which the first pulsed laser beam 321 is radiated again after irradiation with the second pulsed laser beam 322 is longer than the fixed time t.

Here, the irradiation of the predetermined modification position P with the focal spot of the first pulsed laser beam 321 and the focal spot of the second pulsed laser beam 322 may be performed, with the movement of the X-Y-Z stage 35, that is, the scanning of the focal spots, either stopped or performed. The emission period T of the pulsed laser beam 321 (322) is set to so that the focal spots are next to each other without a space therebetween when the focal spot of the laser beam 321 (322) is scanned. In this embodiment, the focal spot of the second pulsed laser beam 322 is radiated directly after the focal spot of the first pulsed laser beam 321 is radiated. Therefore, the fixed time t is shorter than the emission period T, so that the focal spots are radiated to the same predetermined modification position P with almost no difference.

By the above operation, the focal spot of the first pulsed laser beam 321 and then the focal spot of the second pulsed laser beam 322 irradiate the predetermined modification position P, so that the predetermined modification position P is modified by the combined irradiation energy of the two pulsed laser beams 321 and 322. That is, the irradiation energy of the individual pulsed laser beams 321 and 322 is set so that the total irradiation energy thereof reaches necessary energy for modification.

By scanning the substrate 31 with the pulsed laser beams 321 and 322 while repeating the above modification operation, the entire predetermined modification region E is modified to form a modified layer in the substrate 31.

According to this embodiment, the second pulsed laser beam 322 is radiated to the predetermined modification position P before the energy absorbed in the predetermined modification position P of the substrate 31 due to irradiation with the first pulsed laser beam 321 diffuses to the periphery. This increases the absorptance of the energy of the pulsed laser beams 321 and 322 at the predetermined modification position P of the substrate 31. This allows the pulsed laser beams 321 and 322 to be radiated with lower energy than in the related art (a case in which the predetermined modification position P is modified with a single laser oscillator). Thus, even if a large area irradiated with the pulsed laser beams 321 and 322 cannot be provided on the surface of the substrate 31, the predetermined modification position P of the substrate 31 can be satisfactorily modified without generating an unnecessary modified layer on the surface of the substrate 31.

In this embodiment, although an example in which the focal points are scanned by driving the X-Y-Z stage 35 is described, the present invention is not limited thereto; the workpiece 6 and the focal points may be relatively scanned. For example, the laser beams 321 and 322 may be moved relative to the workpiece 6.

### Third Embodiment

This embodiment shows an example in which the removing section performs removal processing using the pulsed laser beam L2 in an underwater environment. That is, removal processing is performed, with the workpiece 6 immersed in liquid.

Referring to FIG. 1, a hermetically sealed chamber 5 in which the workpiece 6 can be accommodated may be provided on the stage 7. The chamber 5 may have a liquid inlet port and a liquid discharge port (not shown) so that liquid can be charged to and discharged from the chamber 5. The workpiece 6 may be fixed in the interior of the chamber 5 secured to the stage 7, and the chamber 5 may be filled with liquid (for example, water). The chamber 5 may have a window 5a through which the pulsed laser beams L1 and L2 pass, and the chamber 5 may be configured to accommodate the workpiece 6 disposed at a position facing the window 5a. In the processing step, removal processing with the pulsed laser beam L2 may be performed in an underwater environment. That is, removal processing may be performed, with the workpiece 6 immersed in liquid. The removal processing in the underwater environment allows pressure generated due to the laser processing to be trapped using the pressure of the liquid, and the pressure impact to the workpiece 6 to be effectively propagated.

### Fourth Embodiment

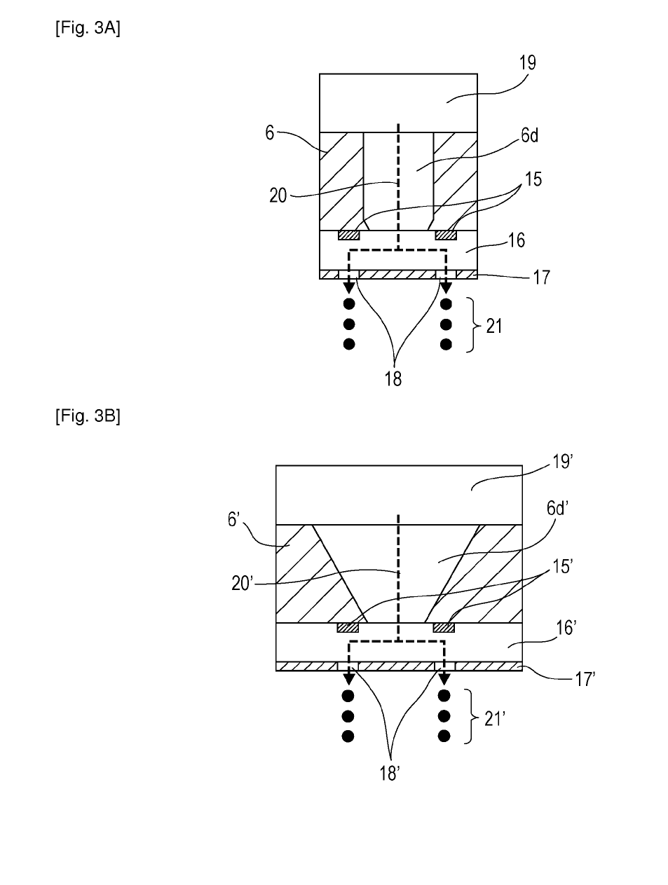

FIGS. 3A and 3B are schematic cross-sectional views of an ink jet head of an ink jet printer. FIG. 3A shows an ink jet head having a groove formed by using a manufacturing method of this embodiment. FIG. 3B shows an ink jet head having a groove formed by conventional removal processing using a pulsed laser beam.

In FIG. 3A, the ink jet head includes a semiconductor substrate 6, an ink tank 19 which is mounted on the upper surface of the semiconductor substrate 6 and which stores ink, and an orifice plate 17 mounted on the lower surface of the semiconductor substrate 6 to form a liquid chamber 16 with the semiconductor substrate 6. The semiconductor substrate 6 has a groove 6d that communicates the ink tank 19 and the liquid chamber 16 with each other to serve as an ink channel 20. The liquid chamber 16 is provided with heaters 15. The orifice plate 17 has ink discharge ports 18 through which ink drops 21 are discharged.

The ink in the ink tank 19 is supplied to the liquid chamber 16 through the groove 6d. Bubbles are formed in the liquid chamber 16 due to momentary heating/cooling of the heaters 15. The ink is pushed up by the bubbles and is discharged as the ink drops 21 smaller than the ink discharge ports 18 formed in the orifice plate 17.

The groove 6d in the semiconductor substrate 6 of the ink jet head is formed by using the laser-beam processing method according to this embodiment. Specifically, in the modified-portion forming step, the portion of the semiconductor substrate 6 that is finally formed into the groove 6d is a predetermined groove-formation region serving as the predetermined removal region, and a modified portion is formed at a portion corresponding to the side wall surface of the groove 6d (that is, the outline of the predetermined groove-formation region) by using the first pulsed laser beam L1. At that time, the modified portion is formed so as to be perpendicular to the surface of the semiconductor substrate 6. Next, in the processing step, a region enclosed by the modified portion, that is, the predetermined groove-formation region, is removed by scanning the second pulsed laser beam L2 in the region enclosed by the modified portion. Thus, the groove 6d having a vertical side wall surface is formed. The thus-formed groove 6d may be used as it is, or alternatively, may be subjected to anisotropic etching in an alkaline etchant for about 15 minutes to finally form a groove shape.

In contrast, FIG. 3B shows an example in which a groove is formed by conventional removal processing using a pulsed laser beam, not by the processing method for forming the vertical groove 6d of this embodiment. In FIG. 3B, the ink jet head includes a semiconductor substrate 6′ and an ink tank 19′ which is mounted on the upper surface of the semiconductor substrate 6′ and which stores ink. The ink jet head further includes an orifice plate 17′ mounted on the lower surface of the semiconductor substrate 6′ to form a liquid chamber 16′ with the semiconductor substrate 6′. The semiconductor substrate 6′ has a groove 6d′ that communicates the ink tank 19′ and the liquid chamber 16′ with each other to serve as an ink channel' 20. The liquid chamber 16′ is provided with heaters 15′. The orifice plate 17′ has ink discharge ports 18′ through which ink drops 21′ are discharged.

The groove 6d shown in FIG. 3A is smaller in width than the groove 6d′ shown in FIG. 3B. A plurality of semiconductor substrates, which is part of the ink jet head, can be cut out from a single silicon wafer. Forming the groove 6d by using the manufacturing method of this embodiment allows a larger number of semiconductor substrates of the ink jet head to be manufactured from a silicon wafer than by using the conventional manufacturing method, thus allowing remarkably reduced costs.

### EXAMPLES

### Example 1

A specific example of the present invention will be described below. First, a specific configuration will be described. In FIG. 1, the laser oscillator 1 used is a Q-switched YAG laser having a YAG fundamental wavelength of 1,064 nanometers and a repetition frequency of 20 kHz. The magnification of the beam-expansion optical system 2 was set to three times. The reflecting mirror 3 was coated with a dielectric multilayer film for 1,064 nanometers and had a reflectivity of 99.5%. The focusing lens 4 used is a 50-power microscope objective lens. The hermetically sealed chamber 5 was made of aluminum. The chamber 5 was provided with the window 5a made of synthetic quartz to allow the laser beams L1 and L2 to be introduced therein. The workpiece 6 was a monocrystal silicon wafer having a thickness of 625 micrometers, whose laser-beam incident surface was mirror-finished. The stage 7 has a triaxial configuration so that it can move in the directions of X-axis and Y-axis and in the direction of the optical axis of the focusing lens (Z-axis direction), whose positioning accuracy was one micrometer. The laser oscillator 8 used is a nitrogen laser having a wavelength of 337.1 nanometers and a repetition frequency of 20 Hz. The magnification of the beam-expansion optical system 9 was set to two times. The reflecting mirror 10 was coated with a dielectric multilayer film for 337.1 nanometers and had a reflectivity of 99.5%. The reflecting mirror 10 was fixed to a galvanometer scanner and can change in reflection angle in the range of −10 degrees or more and +10 degrees or less. The focusing lens 11 used has f-theta characteristics corresponding to the oscillation wavelength of the nitrogen laser. The f-theta characteristics are characteristics in which the moving distance of the focal point due to the angular change, theta, of the galvanometer scanner is expressed as F* theta.

Next, the specific operation will be described hereinbelow. First, the workpiece 6 was fixed onto the stage 7, and the chamber 5 was filled with water. The stage 7 was driven to move the workpiece 6 directly below the detector 12. The detector 12 detected a positioning mark formed on the workpiece 6, and the image processing unit 13 detected the position of the center of gravity of the positioning mark. The signal of the image processing unit 13 was transmitted to the control unit 14 to control the stage 7, and thus, the workpiece 6 was located at a desired processing position directly below the focusing lens 4. The stage 7 was moved, with a laser beam L1 emitted by the laser oscillator 1 focused in the workpiece 6, and the above-described modified portion 6A was formed in the workpiece 6. When the pulse energy of the laser beam L1 that has passed through the focusing lens 4 was 22 microjoules, and the moving speed of the stage 7 was 50 mm/second, the modified region 6a was formed in a laser-beam focal position in the workpiece 6 (see FIGS. 2A and 2B). The modified region 6a formed was about 30 micrometers in the direction of the optical axis of the laser beam L1 (in the depthwise direction) and about two micrometers in the widthwise direction, which was formed in synchronization with the laser pulse along the traveling direction of the laser beam L1.

In this example, a plurality of the modified regions 6a were formed in layers in the direction of the optical axis of the laser beam L1 to form the modified portion 6A with a groove structure from the interior of the workpiece 6 to the surface (see FIG. 2C). That is, the modified portion 6A was formed such that the modified regions 6a are arranged vertically (parallel to the optical axis). Since the position of the focal point P1 is modified, the modified regions 6a could be vertically arranged by vertically scanning the focal point P1 (in this example, sub-scanning).

The end 6b of the modified region 6a closest to the surface of the workpiece 6 reached the surface of the workpiece 6 and formed an outline. However, even if the end 6b of the modified region 6a did not reach to form no outline, the position of the outline in the workpiece 6 could be calculated from the position information of the alignment mark, and thus, there was no problem in laser removal processing to be described below.

Next, the stage 7 was moved to move the workpiece 6 directly below the focusing lens 11. The galvanometer scanner that holds the reflecting mirror 10 was driven, and laser removal processing was performed such that the focal position of the pulsed laser beam L2 moves inside the outline of the modified portion 6A. The pulse energy of the pulsed laser beam L2 that has passed through the focusing lens 11 was 230 microjoules.

Since the workpiece 6 of this example is made of monocrystal silicon, it had a cleavage property along the surface in the crystal orientation. The vicinity of the modified portion 6A had a tendency to cleave (peel off) from the bas material because of residual stress generated due to the modification using the first pulsed laser beam L1. When the silicon was removed using the pulsed laser beam L2, a pressure impact occurred at the processing point P2. When there was an appropriate positional relationship between the focal point P2 and the modified portion 6A, the pressure impact exerted an influence on the modified portion 6A to cause cleavage.

In this example, the focal point P2 of the pulsed laser beam L2 had a diameter of 30 micrometers. When the central position of the focal point P2 came about 15 micrometers close to the outline, cleavage of the modified portion 6A could be recognized. The laser removal processing was advanced, with an appropriate positional relationship with the modified portion 6A formed along the outline of the groove shape maintained, and hence the vertical groove 6d whose side wall surface 6c was formed along the modified portion 6A could be formed.

The case where the groove 6d was formed in the semiconductor substrate 6 of the ink jet head by using the foregoing manufacturing method, shown in FIG. 3A, and the case where the groove 6d′ was formed in the semiconductor substrate 6′ of the ink jet head by using the conventional manufacturing method, shown in FIG. 3B, were compared. The comparison shows that the groove 6d could be reduced in width to about half of the groove 6d′. A plurality of semiconductor substrates, which is part of the ink jet head, can be cut off from, for example, an 8-inch silicon wafer. Forming the groove 6d by using the manufacturing method of this example allows semiconductor substrates about twice as many as those manufactured by using the conventional manufacturing method to be manufactured from a silicon wafer, thus allowing remarkably reduced costs.

In this example, the removal processing using an absorptive pulsed laser beam was performed in an underwater environment. Since the removal processing in an underwater environment traps pressure caused by laser processing with water pressure, a pressure impact to the workpiece 6 could be effectively propagated. As a result, this offers the advantages of decreasing the output of the absorptive pulsed laser beam L2, increasing the distance between the modified portion 6A and the focal point P2 of the absorptive pulsed laser beam L2, and so on, thus increasing the efficiency and reliability of removal processing.

The positional relationship between the modified portion 6A and the focal point P2 of the absorptive pulsed laser beam L2 changes depending on the material of the workpiece 6, transmissive-wavelength pulsed laser conditions, and absorptive-wavelength pulsed laser conditions. Accordingly, the same advantages can be offered by setting conditions that basically cause cleavage, and the positional relationship between the modified portion 6A and the focal point P2 is not particularly limited to the positional relationship of this example.

The present invention is not limited to the foregoing embodiments and example, and various modifications may be made by those skilled in the art within the scope of the technical spirit of the present invention.

Although the workpiece 6 of the embodiments and the example is made of crystal silicon, any material that basically has a cleavage property can offer the same advantages, and the material of the workpiece is not limited to crystal silicon. For example, in addition to crystal silicon, a glass material can be employed. For crystal silicon, the modification in this specification refers to, changing the crystal silicon from crystalline to amorphous, melting, and fine-cracking, and so on, and for a glass material, the modification refers to melting, and fine-cracking, and so on because it originally has an amorphous composition.

In the embodiment and the example, although the workpiece 6 is immersed in liquid before the modified portion 6A is formed, the immersion may be performed any time before removal processing is performed using the second pulsed laser beam L2; the workpiece 6 may be immersed in liquid after the modified-portion forming step.

In the embodiments and the example described above, although the chamber 5 is filled with water to increase the pressure impact, any other liquid that provides a pressure impact due to laser removal processing may be used. Although the embodiments and the example have been described as liquid being effective, the present invention does not exclude a medium other than liquid (that is, gas); gas may be used provided that it is a medium with which a pressure impact due to laser removal processing is given. For gas, the hermetically sealed chamber is not necessarily needed; anything that covers the atmosphere for laser removal processing may be used.

Although the embodiments and the example have been described as applied to the case where the first laser oscillating unit is the first laser oscillator 1 and the second laser oscillating unit is the second laser oscillator 8, the present invention is not limited thereto; a laser oscillator having both of the functions of the first laser oscillating unit and the second laser oscillating unit may be used, if available.

Although the embodiments and the example have been described as applied to the case where the workpiece 6 is subjected to groove processing, the present invention is not limited thereto; a depression, such as a dot-like hole, or a through hole may be formed. The outline of the predetermined removal region of the present invention is not limited to be rectangular in plan view; a predetermined removal region whose outline has any shape, such as a circle, ellipse, or a polygon, in plan view can be removed with high accuracy.

In the embodiments and the example, although the scanning of the focal point P1 of the first pulsed laser beam L1 is performed by moving the stage 7 (that is, the workpiece 6), the laser beam L1 may be moved or both of the laser beam L1 and the stage 7 may be moved. This also applies to the second pulsed laser beam L2; the scanning of the focal point P2 of the pulsed laser beam L2 may be performed by moving the workpiece 6, the pulsed laser beam L2, or both of them.

### Example 2

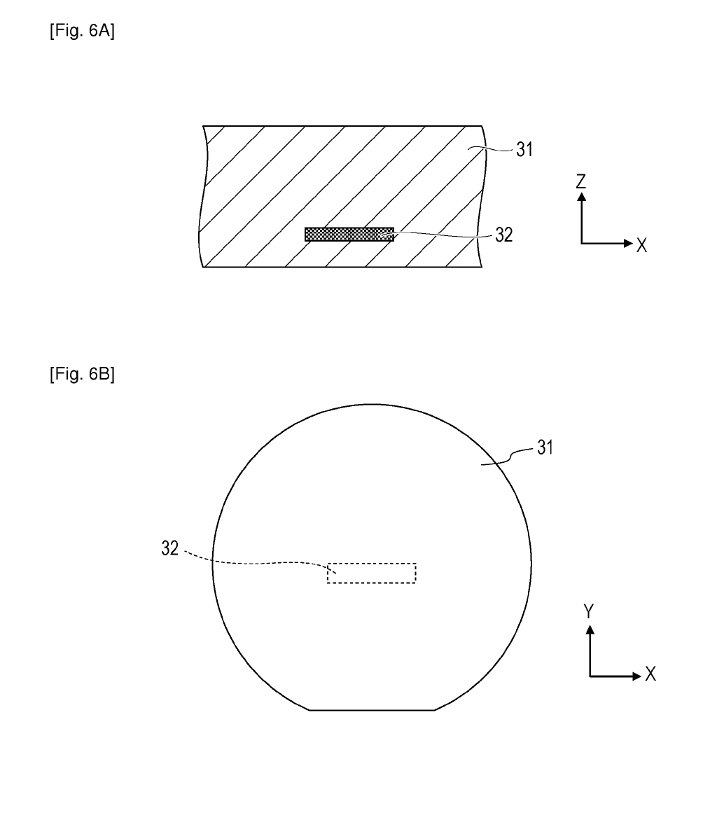

Next, referring to FIG. 4, FIGS. 6A and 6B, FIGS. 7A and 7B, and FIGS. 8A to 8C, an example of a modified-layer forming process of a laser-beam processing method of this example will be described. In this example, an example of a method for processing a leading groove in an ink-jet head substrate by using a removal processing method using a laser beam, in which a modifying laser beam is focused into the substrate 31 to form a modified layer, and the modified layer is used to define the bottom of the machined shape.

The leading groove of the ink-jet head substrate is for leading an etchant during anisotropic etching in the process subsequent to the processing of this example to reduce the period of anisotropy etching, thereby decreasing the width of the ink supply port.

Referring first to FIG. 4, the process of focusing a modifying laser beam into the substrate 31 to form a modified layer of this example will be described. An ink-jet head substrate made of (100) crystal plane of silicon was used as the substrate 31. The substrate 31 used has a mechanism for ejecting ink and a mechanism for the etching process after the processing of this example, such as a heater, electrical wires, an etching stop layer having etching resistance, and an etching protection layer. The thickness of the substrate 31 was set to about 725 micrometers. The substrate 31 was irradiated with the laser beam until a leading groove with a desired shape is formed.

Preferably, the leading groove has a width of 5 to 100 micrometers to introduce an etchant during the subsequent anisotropic etching, to reduce the period of anisotropic etching and to reduce the width of the ink supply port. The depth of the leading groove is preferably 600 to 710 micrometers if the substrate 31 has a thickness of 725 micrometers. The length of the groove is about 5 to 50 mm, depending on the size of the ink jet head.

The focusing lens 33 used had a magnification of 50 times, a numerical aperture NA of 0.55, and a transmittance to the first pulsed laser beam 321 and the second pulsed laser beam 322 of 60% or higher.

The first laser oscillator 341 used was a nanosecond YAG laser that oscillates the first pulsed laser beam 321 at a repetition frequency of 50 kHz. The second laser oscillator 342 used was a nanosecond YAG laser that was adjusted so that it oscillates the second pulsed laser beam 322 at the same repetition frequency of 50 kHz as the first laser oscillator 341, with a delay of one microsecond relative to the first laser oscillator 341.

Thus, the first pulsed laser beam 321 was radiated at intervals of 20 microseconds, and the second pulsed laser beam 322 was radiated always after one microsecond from the first pulsed laser beam 321.

The first pulsed laser beam 321 and the second pulsed laser beam 322 used had a wavelength of 1,064 nanometers, at least part of which had transmittance to the substrate 31. The positions of the focal points of the first pulsed laser beam 321 and the second pulsed laser beam 322 to the substrate 31 were scanned by the automatic X-Y-Z stage 35 so that the position where the modified layer is to be formed was changed.

The first pulsed laser beam 321 oscillated by the first laser oscillator 341 was focused on a predetermined modification position in the substrate 31 via the reflecting mirror 361, the beam splitter 362, and the focusing lens 33.

The intensity of the first pulsed laser beam 321 was set to 0.1 W after passing through the focusing lens 33.

The part of the substrate 31 on which the second pulsed laser beam 322 is focused directly after it is irradiated with the first pulsed laser beam 321 increased in absorption of the second pulsed laser beam 322 due to an increase in temperature and electronic excitation, as compared with that before irradiation with the first pulsed laser beam 321. However, the effect of increasing the absorption of the second pulsed laser beam 322 decreased as time has passed from the irradiation with the first pulsed laser beam 321. Therefore, the second pulsed laser beam 322 was emitted from the second laser oscillator 342 within one microsecond after completion of emission of the first pulsed laser beam 321.

The intensity of the second pulsed laser beam 322 was set so that the temperature of the surface of the substrate 31 does not exceed the melting point of silicon, 1,412 degrees Celsius. Here, the output of the second pulsed laser beam 322 emitted by the second laser oscillator 342 was set to 0.1 W after passing through the focusing lens 33. Accordingly, the total output of the first pulsed laser beam 321 and the second pulsed laser beam 322 was at 0.2 W.

The second pulsed laser beam 322 was focused on the predetermined modification position P in the substrate 31 via the beam splitter 362 and the focusing lens 33 one microsecond after the first pulsed laser beam 321 to form a modified layer at the predetermined modification position P.

At that time, the part of the substrate 31 on which the second pulsed laser beam 322 was focused was improved in absorption of the second pulsed laser beam 322 due to irradiation with the first pulsed laser beam 321, as compared with a state in which it is not irradiated with the first pulsed laser beam 321. Thus, the second pulsed laser beam 322 could form a modified layer with less energy than that when the first pulsed laser beam 321 is not radiated.

Although the processing method of the comparative example could form no modified layer at a position in the substrate far from the surface of the substrate, at which the energy of the focal point of the laser beam decreases, absorption of the laser beam owing to this effect allowed a modified layer to be formed by using the processing method of this example.

The first pulsed laser beam 321 was radiated again 19 microseconds after irradiation with the second pulsed laser beam 322, and the second pulsed laser beam 322 was radiated again one microsecond thereafter. Energy, such as heat and electronic excitation, was diffused into the substrate 31 and the atmosphere around the substrate 31 during 19 microseconds until the first pulsed laser beam 321 is radiated again. This allowed processing while preventing unnecessary thermal damage due to thermal storage and so on. By repeating the irradiation with the first pulsed laser beam 321 and the second pulsed laser beam 322 and scanning of the focal points, the modified layer was formed at a depth of 600 to 710 micrometers, at which removal processing, to be performed later, is to be stopped.

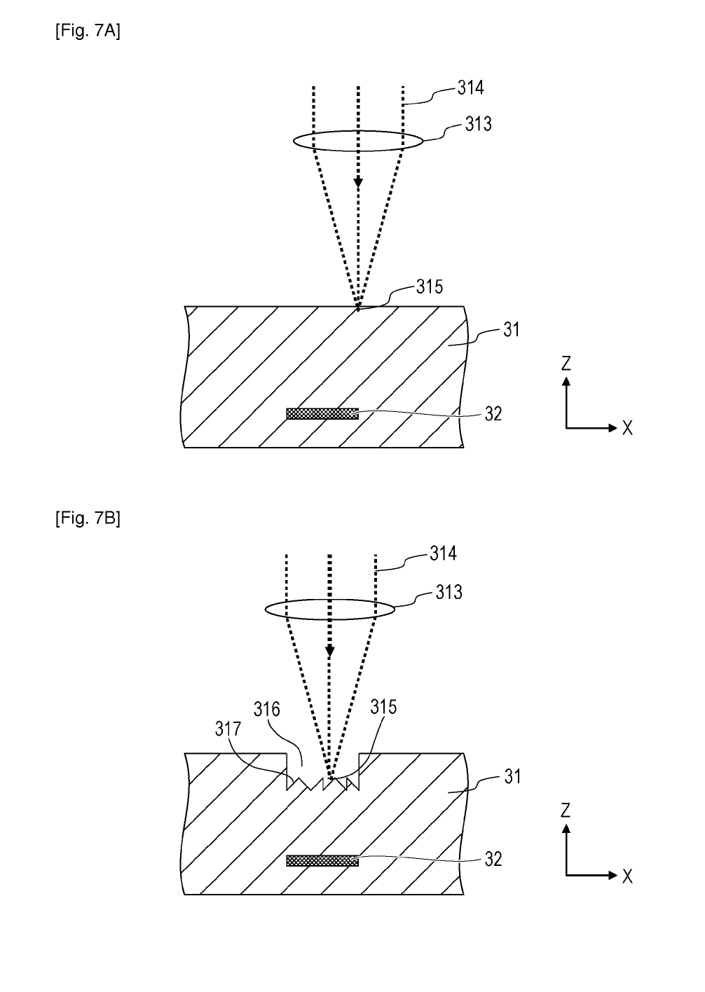

Next, referring to FIGS. 6A and 6B and FIGS. 7A and 7B, an example of the process of processing the leading groove in the ink jet head by using the laser-beam removal processing that uses the modified layer for defining the bottom of the machined shape.

FIG. 6A is a cross-sectional view of the substrate 31 after a modified layer 32 is formed in the substrate 31 of this example by the modified-layer forming process described above. FIG. 6B is a plan view of the substrate 31 after the modified layer 32 is formed in the substrate 31 of this example, as viewed from above the substrate 31. The Y-direction in FIG. 6B is parallel to the surface of the substrate 31 adjacent to the focusing lens 33 and perpendicular to the X-direction.

The modified layer 32 shown in FIGS. 6A and 6B was formed at a portion in the substrate 31, at which the subsequent removal processing is to be stopped. Here, the modified layer 32 was formed at a depth of 600 to 710 micrometers desirable for a leading groove. The modified layer 32 had a width of 30 micrometers and a length of 20 mm.

FIG. 7A is a cross-sectional view of the substrate 31 for explaining the removal processing process for performing removal processing on the substrate 31. FIG. 7A shows a focusing lens 313 for focusing a processing laser beam 314 on the substrate 31. The focusing lens 313 used had a magnification of 50 times, a numerical aperture NA of 0.55, and a processing laser beam transmittance of 60%. The processing laser beam 314 used was a YAG laser having a wavelength of 532 nanometers, an oscillation form of Q-switched pulse, a pulse width of 30 nanoseconds, an output of 20 microjoule/pulse, a laser spot cross-sectional area of 3.1*10⁻⁸ cm², ad a repetition frequency of 80 kHz.

The substrate 31 was scanned with a focal point 315 on which the processing laser beam 314 was focused by the focusing lens 313. The focal point 315 is a point at which the energy density of the processing laser beam 314 is the highest. The focal point 315 was scanned at a speed of 100 mm/s. Thus, removal processing was performed at a location scanned with the focal point 315.

The focusing lens 313 and the processing laser beam 314 have only to have characteristics for removing part of the substrate 31 and are not particularly limited. The oscillation source of the processing laser beam 314 may be any of a solid-state laser, an excimer laser, and a dye laser. The focusing lens 313 may not be damaged by the processing laser beam 314 and preferably has a transmittance of 20% or higher to the processing laser beam 314 so as to focus the processing laser beam 314 on the focal point 315.

FIG. 7B is a cross-sectional view of the substrate 31, showing an example in which the substrate 31 is subjected to part of removal processing in the removal processing process. As shown in FIG. 7B, variations occur in the shape of a portion 316 removed by using the processing laser beam 314 due to processing chips caused by removal processing and variations in the intensity of the processing laser beam 314, which are great particularly at the bottom 317 of the removed portion.

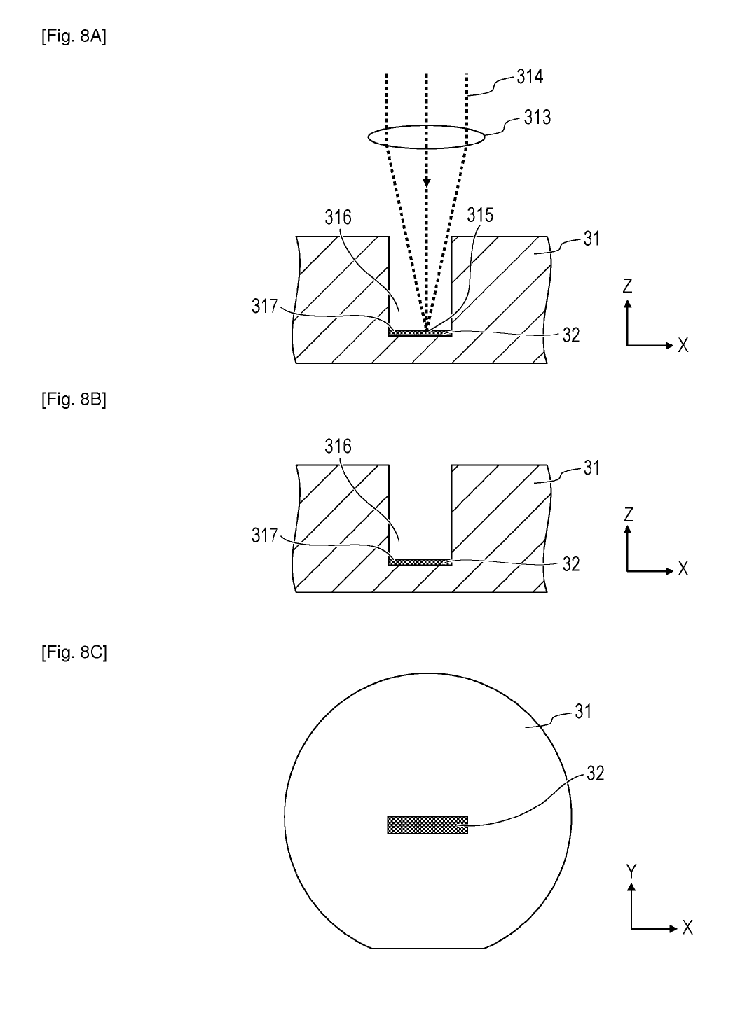

FIG. 8A is a cross-sectional view of the substrate 31, showing a state in which removal processing has reached the modified layer 32 in the substrate 31 in the removal processing process. Even if part of the bottom 317 of the portion 316 removed by using the processing laser beam 314 reached the modified layer 32 earlier due to variations in processing, the modified layer 32 is difficult to be removed, and hence variations in the shape of the bottom 317 of the removed portion 316 can be reduced.

FIG. 8B is a cross-sectional view of the substrate 31 subjected to the removal processing in the removal processing process. FIG. 8C is a plan view of the substrate 31 subjected to the removal processing in the removal processing process, as viewed from above the substrate 31. As shown in FIGS. 8B and 8C, part of the substrate 31 is removed by the removal processing, so that the modified layer 32 is exposed. Since the shape of removal processing is defined by the modified layer 32, variations at the bottom 317 of the removed portion 316 are reduced, and the machined bottom 317 was formed at a depth from 620 micrometers to 700 micrometers, thus allowing a preferable depth as the modified groove to be provided.

With the laser-beam processing method of this example, in the processing method involving focusing laser beams on the substrate 31 to form a modified layer at part of the interior of the substrate 31, the second pulsed laser beam 322 was radiated one microsecond after completion of irradiation with the first pulsed laser beam 321. This could increase absorption of the second pulsed laser beam 322 due to irradiation with the first pulsed laser beam 321, which allowed the second pulsed laser beam 322 to be radiated with high absorption, thus allowing the modified layer to be formed. Thus, the energy efficiency could be increased as compared with the processing method of the comparative example, and hence the modified layer could be formed with low energy.

Since the modified layer can be formed with low energy, the energy density of the laser beam on the surface of the substrate 31 could also be decreased. This could prevent unnecessary modification on the surface of the substrate 31 and simplified formation of the modified layer also at a predetermined modification position in the substrate 31 remote from the surface of the substrate 31.

Even if a sufficient laser beam irradiation area cannot be provided on the surface of the substrate 31, the modified layer could be formed in the substrate 31 without the need for unnecessary processing on the surface of the substrate 31 as compared with the processing method of the comparative example.

The laser processing speed in the laser removal processing is lower at the target modified layer than a non-modified portion. Accordingly, the modified layer can be formed at a portion at which the removal processing is to be stopped in the laser removal processing and can be used as a stop layer. Even if the laser removal processing speed varies, the use of the modified layer as a stop layer allows the variations to be absorbed at the modified layer in which the removing speed is low, and hence the accuracy of processing shape can be improved. This can reduce variations in the shape of the leading groove of the ink-jet head substrate 31.

The present invention is not limited to the foregoing embodiments and examples, and various modifications can be made by those skilled in the art within the technical spirit of the present invention.

Although the above example has been described as applied to the case where the modified layer is used as a stop layer, formation of the modified layer of the present invention may also be used for laser dicing in which the modified layer is formed along a predetermined chip division line and chip division is performed by tape expansion or the like.

If the workpiece has a cleavage property, the modified layer tends to peel off from the base material. This allows the present invention to be used also for a processing method of forming a desired shape along the outline of a predetermined laser removal processing region using the peeling-off of the modified layer from the base material.

The modified layer forming method of the present invention can also be used for a removing method of forming a modified layer by using a laser beam and thereafter performing wet etching by using the characteristic that the removing speed of wet etching is higher at the target modified layer than at the non-modified portion.

Furthermore, although the second embodiment has been described as applied to the case where the pulsed laser beams 321 and 322 are radiated at a fixed emission period, the present invention is not limited thereto; the emission period may be changed depending on the change in scanning speed.

Furthermore, although the second embodiment has been described as applied to the case where the two laser oscillators 341 and 342 are used, three or more laser oscillators may be used for modification. In this case, two laser oscillators selected from the plurality of laser oscillators may have the relationship between the first laser oscillator and the second laser oscillator, and the pulsed laser beams from the laser oscillators may sequentially emit pulsed laser beams at intervals of fixed time t, that is, at intervals of one microsecond or less. The energy of the pulsed laser beams may be set so that the total energy meets the required energy for modification.

Although the second embodiment has been described as applied to the case where the focal spots of the first pulsed laser beam (second pulsed laser beam) do not irradiate the same position of the substrate, the focal spots may irradiate an irradiated position of the substrate.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-222731, filed Oct. 7, 2011 and No. 2011-274375, filed Dec. 15, 2011, which are hereby incorporated by reference herein in their entirety.

### REFERENCE SIGNS LIST

1 laser oscillator (first laser oscillating unit)
4 focusing lens
5 chamber
6 workpiece
6A modified portion
8 laser oscillator (second laser oscillating unit)
11 focusing lens
100 laser-beam processing apparatus

1. A laser-beam processing method comprising the steps of:
forming a modified portion, to form the modified portion in a workpiece by scanning the focal point of a pulsed laser beam having a wavelength that exhibits transmittance to the workpiece along the outline of a predetermined removal region; and
removing a region enclosed by the modified portion.

2. The laser-beam processing method according to claim 1, wherein the pulsed laser beam having a wavelength that exhibits transmittance includes a first pulsed laser beam and a second pulsed laser beam; and
the second pulsed laser beam is radiated to the position irradiated with the first pulsed laser beam in one microsecond after the first pulsed laser beam is radiated for a fixed period of time.

3. The laser-beam processing method according to claim 1, wherein the removal processing is performed by scanning the pulsed laser beam having a wavelength that exhibits transmittance to the workpiece in the region enclosed by the modified portion.

4. The laser-beam processing method according to claim 3, wherein the removal processing is performed, with the workpiece immersed in liquid.

5. The laser-beam processing method according to claim 1, wherein the workpiece is made of crystal silicon.

6. A method for manufacturing an ink jet head including a semiconductor substrate having a groove for supplying ink from an ink tank to an ink discharge port, the method comprising the steps of:
forming a modified region, to form the modified portion in a semiconductor substrate by scanning the focal point of a pulsed laser beam having a wavelength that exhibits transmittance to the semiconductor substrate along the outline of a predetermined groove-formation region; and
removing a region enclosed by the modified portion to form the groove.

7. The method for manufacturing an ink jet head, according to claim 6, wherein the pulsed laser beam having a wavelength that exhibits transmittance to the semiconductor substrate includes a first pulsed laser beam and a second pulsed laser beam; and
the second pulsed laser beam is radiated to the position irradiated with the first pulsed laser beam in one microsecond after the first pulsed laser beam is radiated for a fixed period of time.

8. The method for manufacturing an ink jet head, according to claim 6, wherein the removal processing is performed by scanning the pulsed laser beam having a wavelength that exhibits transmittance to the semiconductor substrate in the region enclosed by the modified portion.

9. The method for manufacturing an ink jet head, according to claim 8, wherein the removal processing is performed, with the semiconductor substrate immersed in liquid.

10. A laser-beam processing apparatus comprising:
a first laser oscillator that emits a first pulsed laser beam having a wavelength that exhibits light transmittance to a workpiece;
a second laser oscillator that emits a second pulsed laser beam having a wavelength that exhibits light transmittance to the workpiece;
an optical system that guides the first pulsed laser beam emitted by the first laser oscillator and the second pulsed laser beam emitted by the second laser oscillator to a common optical path;
a focusing lens disposed in the common optical path, the focusing lens focusing the first pulsed laser beam and the second pulsed laser beam guided to the common optical path on a predetermined modification position of the workpiece;
a control unit that controls the pulsed laser beam emission timings of the first laser oscillator and the second laser oscillator so that, when the focal spots of the first pulsed laser beam and the second pulsed laser beam irradiate the predetermined modification position to modify the predetermined modification position, the second laser oscillator emits the second pulsed laser beam in one microsecond after the first laser oscillator completes emission of the first pulsed laser beam;
a movable stage on which the workpiece is placed;
a laser oscillator that emits a pulsed laser beam having a wavelength that exhibits absorption to the workpiece; and
a focusing lens that focuses the pulsed laser beam emitted by the laser oscillator that emits the pulsed laser beam having a wavelength that exhibits absorption on a region enclosed by the predetermined modification position of the workpiece.

11. The laser-beam processing apparatus according to claim 10, further comprising a chamber on the stage, the chamber being capable of accommodating the workpiece and capable of being charged with liquid and discharging the liquid therefrom.
